(19) United States
(12) Patent Application Publication
(10) Pub. No.: US 2020/0175622 A1
(43) Pub. Date: Jun. 4, 2020

(54) PROCESSING LEDGER TRANSACTIONS IN A BLOCKCHAIN

(71) Applicant: Alibaba Group Holding Limited, George Town (KY)

(72) Inventors: Xuetao Lin, Hangzhou (CN); Yanan Zhang, Hangzhou (CN); Wuwei Liu, Hangzhou (CN); Wenxia Zhang, Hangzhou (CN)

(73) Assignee: Alibaba Group Holding Limited, George Town (KY)

(21) Appl. No.: 16/786,713

(22) Filed: Feb. 10, 2020

Related U.S. Application Data
(63) Continuation of application No. PCT/CN2020/071870, filed on Jan. 14, 2020.

(30) Foreign Application Priority Data
Apr. 23, 2019 (CN) 201910328587.1

(51) Int. Cl. G06Q 50/16; H04L 9/06; G06Q 40/04

(52) U.S. Cl. CPC G06Q 50/163; H04L 9/0643; H04L 2209/38; H04L 2209/56; G06Q 40/04

(57) ABSTRACT

Implementations of this specification provide a method and an apparatus for processing ledger transactions using smart contracts in a blockchain. An example method performed by a blockchain node includes receiving data characterizing an ledger transaction for a target property, the data characterizing the ledger transaction including a unique identification code of the target property and a ledger content; generating the ledger transaction based on the data characterizing the ledger transaction for the target property, and releasing the ledger transaction to a block of the blockchain; and after the ledger transaction is verified by a consensus of the blockchain, storing the unique identification code of the target property and the ledger content in a distributed database of the blockchain.

### CROSS-REFERENCE TO RELATED APPLICATIONS

This application is a continuation of PCT Application No. PCT/CN020/071870, filed on Jan. 14, 2020, which claims priority to Chinese Patent Application No. 201910328587.1, filed on Apr. 23, 2019, and each application is hereby incorporated by reference in its entirety.

### TECHNICAL FIELD

One or more embodiments of the present disclosure relate to the field of data processing technology, and in particular, to a method and an apparatus for storing property information based on a blockchain, and a method and an apparatus for maintaining property information based on a blockchain.

### BACKGROUND

Blockchain technology, also known as distributed ledger technology, is an emerging technology in which several computing devices participate in “accounting” and jointly maintain a complete distributed database. Since blockchain technology has the characteristics of decentralization, openness and transparency, each computing device can participate in database records, and data can be quickly synchronized between computing devices, blockchain technology has been widely used in many fields.

### SUMMARY

In view of this, one or more embodiments of the present disclosure provide a method and an apparatus for storing property information based on a blockchain, a method and an apparatus for maintaining property information based on a blockchain, a computer device and a computer-readable storage medium.

To achieve the above objective, one or more embodiments of the present disclosure provide technical solutions as follows.

According to a first aspect of one or more embodiments of the present disclosure, a method for storing property information is provided. The method includes: receiving, by a node of the blockchain, a ledger transaction associated with a target property, wherein the ledger transaction comprises a unique identification code of the target property and ledger content; and after the ledger transaction is verified by a consensus of the blockchain nodes, storing the unique identification code of the target property and the ledger content in a distributed database provided by the blockchain.

According to a second aspect of one or more embodiments of the present disclosure, a method for maintaining property information based on a blockchain is provided. The method includes: obtaining, by a node of the blockchain, a ledger transaction associated with a target property from a distributed database provided by the blockchain, wherein the ledger transaction comprises a unique identification code of the target property and ledger content; and executing an application logic based on the ledger transaction.

According to a third aspect of one or more embodiments of the present disclosure, an apparatus for storing property information based on a blockchain is provided. The apparatus is applied to a node of the blockchain, and the apparatus comprises: a receiving unit configured to receive a ledger transaction associated with a target property, wherein the ledger transaction comprises a unique identification code of the target property and a ledger content; and a storing unit configured to, after the ledger transaction is verified by a consensus of the blockchain nodes, store the unique identification code of the target property and the ledger content in a distributed database provided by the blockchain.

According to a fourth aspect of one or more embodiments of the present disclosure, an apparatus for maintaining property information based on a blockchain is provided. The apparatus is applied to a node of the blockchain, and the apparatus includes: an obtaining unit configured to obtain an ledger transaction associated with a target property from a distributed database provided by the blockchain, wherein the ledger transaction comprises a unique identification code of the target property and a ledger content; and an execution unit configured to execute an application logic based on the ledger transaction.

According to a fifth aspect of one or more embodiments of the present disclosure, a computer device is provided, including: a memory and a processor. A computer program executable by the processor is stored in the memory. The processor when running the computer program, executes the method for storing property information based on a blockchain, which is performed by a node of the blockchain.

According to a sixth aspect of one or more embodiments of the present disclosure, a computer device is provided, including: a memory and a processor. A computer program executable by the processor is stored in the memory. The processor when running the computer program, executes the method for maintaining property information based on a blockchain, which is performed by a node of the blockchain.

According to a seventh aspect of one or more embodiments of the present disclosure, a computer-readable storage medium is provided. The computer-readable storage medium has computer programs stored thereon, when run by a processor, executes the method for storing property information based on a blockchain, which is performed by a node of the blockchain.

According to an eighth aspect of one or more embodiments of the present disclosure, a computer-readable storage medium is provided. The computer-readable storage medium has computer programs stored thereon, when run by a processor, executes the method for maintaining property information based on a blockchain, which is performed by a node of the blockchain.

As can be seen from the above technical solutions, the method and the apparatus for storing property information based on a blockchain, the method and the apparatus for maintaining property information based on a blockchain, the computer device and the computer-readable storage medium provided in this disclosure store the unique identification code and ledger content of the target property in the distributed database provided by the blockchain correspondingly. Based on the consensus mechanism and anti-tampering mechanism of the blockchain, it can effectively maintain the property information of the target property, so that each node of the blockchain can share and search for the property information of the target property. The method and the apparatus for storing property information based on a blockchain, the method and the apparatus for maintaining property information based on a blockchain, the computer device and the computer-readable storage medium provided in this disclosure execute the application logic based on the ledger transaction, and can provide an effective data foundation for various application logics.

### BRIEF DESCRIPTION OF THE DRAWINGS

FIG. 1 is a schematic flowchart illustrating a method for storing property information based on a blockchain according to an embodiment provided in this disclosure;

FIG. 2 is a schematic diagram illustrating a reference relationship of three ledger transactions of a target property shown in an embodiment provided in this disclosure;

FIG. 3 is a schematic flowchart illustrating a method for maintaining property information based on a blockchain according to an embodiment provided in this disclosure;

FIG. 4 is a schematic diagram illustrating an apparatus for storing property information based on a blockchain, which is applied to a node according to an embodiment provided in this disclosure;

FIG. 5 is a schematic diagram illustrating an apparatus for maintaining property information based on a blockchain, which is applied to a node according to an embodiment provided in this disclosure;

FIG. 6 is a hardware structure diagram of an embodiment of an apparatus for storing property information based on a blockchain or an apparatus for maintaining property information based on a blockchain provided in this disclosure.

### DETAILED DESCRIPTION OF THE EMBODIMENTS

Embodiments will be described in detail here, examples of which are illustrated in the accompanying drawings. When the following description refers to the accompanying drawings, the same numerals in different drawings represent the same or similar elements unless otherwise indicated. The embodiments described in the following examples do not represent all embodiments consistent with one or more embodiments of the present disclosure. Rather, they are merely examples of apparatuses and methods consistent with some aspects of one or more embodiments of the present disclosure, as detailed in the appended claims.

It should be noted that, in other embodiments, the steps of the corresponding method are not necessarily performed in the order shown and described in the present disclosure. In some embodiments, the method can include more or fewer steps than described in the present disclosure. In addition, a single step described in the present disclosure can be divided into multiple steps for description in other embodiments. Multiple steps described in the present disclosure can be combined into a single step in some embodiments.

Conventional property (e.g., a commercial property, a residential property) information management is usually performed by a centralized platform. In some examples with reference to some embodiments as described below, a property can refer to a property. However, whether it is the property management platform of the property construction department of the government or the management platforms of various property agency commercial organizations, it may be difficult to share and communicate information with other platforms to save information collection costs and reduce the probability of conflicting and errors in property management information (such as repeated rental, property filing information errors, etc.).

In order to solve the problems, one or more embodiments of the present disclosure provide a method for storing property information based on a blockchain, which can be applied to any node on the blockchain.

The blockchain described in one or more examples of the present disclosure can refer to a P2P network system with a distributed data storage structure reached by each node through a consensus mechanism. The data in the blockchain is distributed over “blocks” successively in terms of time, the latter block contains data summary of the previous block, and according to the consensus mechanism (such as POW, POS, DPOS, or PBFT, etc.), full data backup is achieved on all or some of the nodes. Those skilled in the art are familiar with the fact that since the blockchain network system operates under the corresponding consensus mechanism, it may be difficult to tamper the data that has been included in the blockchain database by any node. For example, a blockchain maintaining POW consensus can have existing data be tampered under at least an attack with 51% computing power of the whole network. Therefore, the blockchain system has the characteristics of ensuring data security and anti-tampering, which cannot be matched by other centralized database systems. It can be known that the data collected in the distributed database provided by the blockchain will not be attacked or tampered with, thereby ensuring the authenticity and reliability of the data information stored in the distributed database provided by the blockchain.

Example types of blockchain networks can include public blockchain networks, private blockchain networks, and consortium blockchain networks. The public blockchain network is open to all entities using the P2P network and participating in the consensus process. The private blockchain network is provided to an entity that centrally controls read and write permissions. The consortium blockchain network is provided to a selected entity group (the selected entity group controls the consensus process) and includes an access control layer. The embodiments of this disclosure can be implemented in any suitable type of blockchain network.

A node (or a node device) described in one or more embodiments of this disclosure refers to a node that can join the blockchain by following a corresponding node protocol and running a node protocol program for installation. Those skilled in the art may refer to a node that has a full backup of the blockchain distributed database as a full node, and refer to a node that has a partial backup of the blockchain distributed database (such as data with only a block header) as light nodes. In one or more embodiments of the present disclosure, the node types of the nodes are not limited.

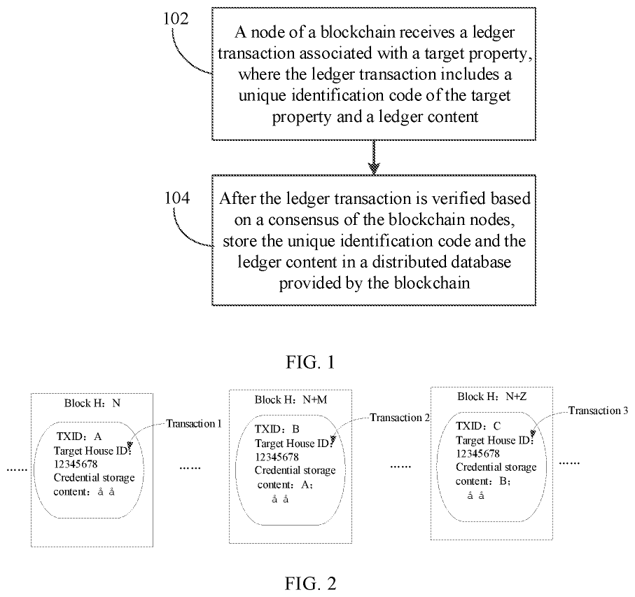

As shown in FIG. 1, a method for storing property information based on a blockchain provided by one or more embodiments of this disclosure includes the following steps.

At step 102, a node of the blockchain receives a ledger transaction associated with a target property, where the ledger transaction includes a unique identification code of the target property and a ledger content.

A transaction described in one or more embodiments in this disclosure refers to data created by a node of a blockchain and can be published to blocks of the blockchain. The transactions in the blockchain are classified into transactions in a narrow sense and transactions in a broad sense. A transaction in a narrow sense refers to an asset transfer published by a user to the blockchain. For example, in a traditional Bitcoin blockchain network, a transaction can be a transfer initiated by a user in the blockchain. A transaction in a broad sense refers to business data with business intent published by a user entity to the blockchain through a node, such as the ledger transaction for storing ledger content and the unique identification code of the target property as described in this embodiment.

Since a plurality of nodes on the blockchain (such as nodes of a plurality of property agencies) each as a notary can store property information for a target property on the blockchain, in order to unify the coding logic of the property identification code of each node to prevent the same target property from having multiple identification codes, the unique identification codes of the target property described in the one or more embodiments can be generated by a smart contract running on the blockchain.

To further provide a background to some embodiments of this disclosure, in a blockchain network, applications can be developed, tested, and deployed for execution within the blockchain network. Example applications can include, but are not limited to, smart contracts. A smart contract can be described as a digital representation of a real-world legal contract that has contract terms that affect the parties. The smart contract is implemented, stored, updated (as needed), and executed within the blockchain network. Contract parties (for example, buyers and sellers) associated with a smart contract are represented as nodes in the blockchain network.

In some examples, the smart contract can store data that can be used to store information, facts, associations, balances, and any other information needed to implement contract execution logic. A smart contract can be described as a computer-executable program consisting of functions, in which an instance of the smart contract can be created and a function invoked to execute the logic specified by the smart contract.

In terms of technology, smart contracts can be implemented based on objects and object-oriented classes. For example, the terms and components of a smart contract can be represented as object handled by an application that implements the smart contract. A smart contract (or an object in a smart contract) can invoke another smart contract (or an object in the same smart contract) like other object-oriented objects. For example, an invoking made by an object can be invoking creating, updating, deleting, propagating, or communicating with an object of another class. Invoking between objects can be implemented by functions, methods, application programming interfaces (APIs), or other invoking mechanisms. For example, a first object can invoke a function to create a second object.

It can be known from the above that, in yet another embodiment shown, the unique identification code of the target property is obtained by a node of the blockchain invoking a smart contract deployed on the blockchain. The smart contract declares a logic that generates the unique identification code for the target property based on attribute information of the target property. The attribute information of the target property includes information such as an address of the target property, ownership of the property right, or a serial number of the real estate certificate, and is used to uniquely identify the target property.

Those skilled in the art may know that the logical rules declared by the smart contract can be included in a distributed database provided by the blockchain after being subject to the consensus verification of the nodes of the blockchain. Therefore, obtaining the unique identification code for the target property by invoking the smart contract can ensure the uniformity of the rules for obtaining the unique identification code of the target property, and the one-to-one correspondence between the unique identification code and the target property.

This embodiment does not limit the execution manner for invoking the smart contract. It can be executed locally on the node to obtain, or an invoking transaction can be published on the blockchain to execute, so that the execution result, that is, the unique identification code of the target property, is stored in the distributed database provided by the blockchain.

The ledger content described in one or more of the above embodiments can include a variety of specific information contents according to specific business scenarios or requirements for ledger. For example, the ledger content includes the attribute information of the target property or the rental contract information or the usage sensing information. As mentioned above, the attribution information of the target property can include the general information of the property, such as the address of the target property, or the ownership of the property, or the serial number of the real estate certificate. The contract information can include the contract information of the sale or rental of the target property. The usage sensing information is obtained through sensing by Internet of Things (IoT) sensors installed in the target property and transmitted to the node to capture the occupancy information of the target property (such as door opening and closing information, water, electricity and gas usage information, etc.).

In some embodiments, the ledger content further includes respective hash values of other transactions (TXID) stored in the distributed database provided by the blockchain, and said other ledger transaction include the unique identification code of the target property and another ledger content. By collecting the hash value of other ledger transaction stored on the blockchain into the ledger content of the ledger transaction described above, the ledger transaction is associated with the other ledger transaction. Said other ledger transaction can also include a hash value of other ledger transaction about the target property, and so on. Thereby, a ledger information data link of the target property can be established to facilitate each node to quickly search out information about various ledger contents regarding the target property.

As shown in FIG. 2, the blocks of the blockchain stores three pieces of transaction histories about the target property (with an identification code: 12345678), which are respectively a transaction 1 used to store the general information of the target property, a transaction 2 used to store a rental contract of the target property, and a transaction 3 used to store actual occupancy of the target property in the same rental period of the rental contract of the target property. The ledger content of the transaction 2 includes a hash value A of the transaction 1, and the ledger content of the transaction 3 includes a hash value B of the transaction 2. In this way, the nodes on the blockchain can obtain a ledger “data chain” as shown in FIG. 2.

Those skilled in the art may know that FIG. 2 is an example illustrating the contents of the ledger transactions of the target property described in this disclosure. The three transactions can be sent to the blockchain by the same node. It can also be sent to the blockchain by different nodes. Regarding the same target property, the number of transactions and ordering states contained in the ledger data chain are not limited to the single-chain type shown in FIG. 2. For example, the transaction 3 can also include the hash value A of the transaction 1, which will not be elaborated herein.

At step 104, after the ledger transaction (e.g., the unique identification code and the ledger content) is verified based on consensus of the blockchain nodes, the ledger transaction including the unique identification code and the ledger content is stored in the distributed database provided by the blockchain.

The detailed process of uploading the unique identification code of the target property and the ledger content described in some embodiments to the distributed database provided by the blockchain can be set up according to the verification mechanism and consensus mechanism of the blockchain. In an embodiment, publishing the ledger transaction to the distributed database provided by the blockchain includes: after a bookkeeping node in the blockchain has verified the transaction, adding the ledger transaction to a candidate block; determining a consensus accounting node that satisfies the blockchain consensus mechanism from the bookkeeping nodes; broadcasting the candidate block to the nodes of the blockchain by the consensus accounting node; and after the candidate block is verified by a preset number of nodes of the blockchain, adding the candidate block as the latest block to the distributed database provided by the blockchain.

In some embodiments, the bookkeeping node refers to the node having the authority to generate a candidate block. According to the consensus mechanism of the blockchain, a consensus accounting node can be determined from the bookkeeping nodes for the candidate block. The consensus mechanism can include Proof of Work (POW), or Proof of Stake (POS), or Delegated Proof of Stake (DPOS), or Practical Byzantine Fault Tolerance (PBFT) commonly used in consortium chains.

In some cases, the blockchain network described in the one or more embodiments of the present disclosure can be structured as a consortium chain, and the nodes are used as consortium chain nodes, for example, after each property agency collects the information about property source information or signs the property rental contract, the property agency sends an ledger transaction about the target property to the consortium chain. Compared with the public chain, the consensus algorithm used by the consortium chain can be highly efficient and can meet the demand of high-frequency transaction volumes, such as the ledger transactions for the properties which are frequently generated. The delay of consensus can be low, which can basically meet the real-time processing requirement. It can quickly and in real time store a ledger transaction in a newly generated block of the blockchain. Moreover, the trusted nodes in the consortium chain network (such as nodes on the government institutions) are taken as pre-selected accounting nodes, it can take into account both security and stability. In addition, the consensus algorithm of the consortium chain (such as PBFT) usually does not consume too much computing power, does not necessarily require circulation of tokens, so it has good usability.

The unique identification code of the target property and the ledger content can be stored in the form of a transaction in the block of the distributed database provided by the blockchain. In another embodiment, the ledger transaction invokes a storage smart contract deployed on the blockchain to execute a storage logic declared by the storage smart contract, where the storage logic is executed based on the unique identification code of the target property and the ledger content. The storage logic performed by the storage smart contract can store the unique identification code and ledger content in the “state database” of the blockchain, for example, in the “storage” content of the smart contract account, or in the Receipts tree corresponding to the execution of the smart contract. As such, the smart contract manages and maintains the unique identification code and the ledger content, to perform addition, deletion, search, and modification on the data content. Those skilled in the art should know that the “storage” content of a smart contract account can be stored in the “state tree” of the contract account in the form of an MPT tree, and the “state tree” or the “receipt tree” is stored in in the local database of each node of the blockchain as the content of the “state database” in the distributed database provided by the blockchain

Regarding the content of the storage logic, it can be determined based on the service scenario and the type of the ledger content. For example, when the ledger content is rental contract information of the target property, the storage smart contract will determine the information content of the rental contract to be stored as a notary is in conflict with a stored and valid rental contract for the target property as a notary, based on the unique identification of the target property and the information content of the rental contract in the ledger transaction. If there is no conflict, the unique identification of the target property and the information content of the rental contract are stored and recorded. If there is a conflict, the storage smart contract can generate an execution result of ledger not allowed, without adding or modifying the “state database” of the existing stored property information. The execution result can be written in the transaction log. The transaction log is eventually stored as part of the transaction receipt in the Receipts tree described earlier.

Through the one or more embodiments of the method for storing property information based on the blockchain, the conflict errors of property information can be effectively reduced, and an effective storage structure for various storage information of the target property can be established.

Corresponding to some embodiments of the method storing property information based on the blockchain, this disclosure also provides some embodiments of a method for maintaining property information based on the blockchain.

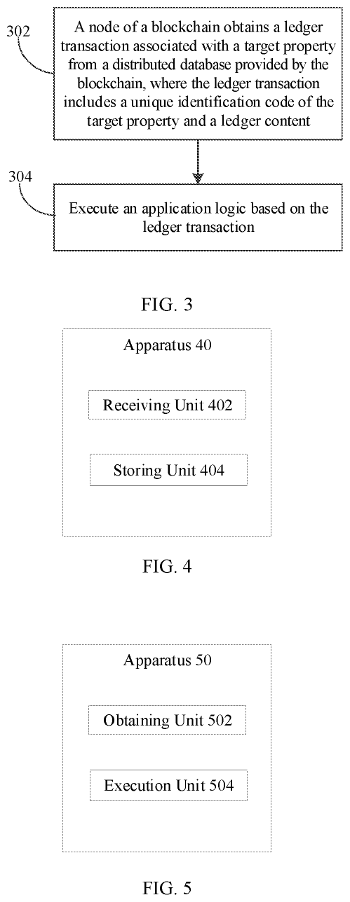

As shown in FIG. 3, a method for maintaining property information based on a blockchain provided by an embodiment of the present disclosure includes the following steps.

At step 302, a node of the blockchain obtains a ledger transaction associated with a target property from a distributed database provided by the blockchain, where the ledger transaction includes a unique identification code of the target property and a ledger content.

At step 304, application logic is executed based on the ledger transaction.

In some embodiments, the unique identification code of the target property is obtained by a sending node of the ledger transaction invoking a smart contract deployed on the blockchain, and the smart contract declares a logic that generates the unique identification code for the target property based on attribute information of the target property.

The deployment and invoking of the smart contract related to this example method have been described in detail in some embodiments of the method for storing property information, which will not be elaborated herein.

In some embodiments, the ledger content includes attribute information of the target property. Executing the application logic includes: executing a creation logic for a contract related to the target property.

As described above, the attribute information of the target property includes address of the target property, ownership of the property right, or a serial number of the real estate certificate. The contract related to the target property includes a rental contract or a sales contract, which can be created by the node corresponding to each property agency or government property management department.

Based on the blockchain consensus mechanism and anti-tampering mechanism, the creation logic for the contract related to the target property, which is executed in accordance with the ledger transaction described in this embodiment, it can ensure the authenticity and accuracy of the attribute information of the target property based on the contract creation, to prevent an invalid contract or increased costs due to incorrect property information.

In some embodiments, the ledger content includes contract information related to the target property. Executing the application logic includes: performing contract information management on the target property or rental-sale information management on the target property.

As mentioned above, when the ledger transaction of the target property according to the embodiment is to store the contract information related to the target property, the node corresponding to each property agency, e.g., the government property management department (such as the property construction department), can perform contract information management or rental-sale information management on the target property based on the obtained ledger transaction.

In the existing property rental management, due to the diversification of market participants, the process of property usage can be divided according to time and space, which has caused many management defects in the field. For example, multiple renters in one property, time superposition (the contracted rental period is longer than the real rentable period), and rental from non-property owner, and so on. These conditions have led to various problems, including rental fraud, blind areas of migration management, and so on. With the introduction of the national rental management policy, more and more urban living rights will be bound to rental property in the future, such as the latest rental property personal tax deduction policy. Under the general background of the same rights for renting and sharing in the future, renters will enjoy the same rights as buyers, and these need to identify and manage the uniqueness and compliance of the property.

As described in some embodiments, the contract information management or rental-sale information management performed based on the ledger transaction for storing the rental contract related to the target property as a notary, is based on the consensus and verification of multiple nodes on the blockchain. This provide a basis of accurate information for the uniqueness and compliance of the target property, and facilitate the nodes of various government institutions to carry out the rental-sale information management on the target property.

In some embodiments, the ledger content includes usage sensing information of the target property, and the usage sensing information is obtained by an IoT sensor provided at the target property. Executing the application logic includes: executing management on actual occupancy of the target property.

As mentioned above, government institutions sometimes need to examine the actual occupancy of properties when implementing property rental management, to determine whether the tenant actually rents the target property. Therefore, in this case, by obtaining a ledger transaction including the usage sensing information of the target property (the usage sensing information is obtained by the IoT sensor installed in the target property), the usage management on the target property is performed. Of course, the usage management on the target property can also be performed in other business application scenarios, which is not limited here.

In some embodiments, the ledger content further includes respective hash values of other ledger transaction stored in the distributed database provided by the blockchain. The method further includes: obtaining other ledger transaction from the distributed database provided by the blockchain; and executing the application logic includes: performing usage process management on the target property.

As described above, the hash value of other ledger transaction stored on the blockchain is collected into the ledger content of the ledger transaction, thereby associating the ledger transaction with the other ledger transaction. For example, since said other ledger transactions can also include a hash value of other ledger transaction related to the target property, and so on, a ledger information data link related to the target property can be established to facilitate each node to quickly search out information about various ledger contents regarding the target property which is stored, so as to facilitate the usage process management on the target property.

In some cases, the blockchain network described in the one or more embodiments of the present disclosure can be structured as a consortium chain, and the nodes are used as consortium chain nodes. For example, each property agency can execute the signing of a property rental and sale contract based on the ledger transaction about the attribute information of the target property which is obtained on the blockchain. Or, the node of the government related housing and construction institutions can perform the rental-sale management or the usage management on properties under the jurisdiction thereof, based on the ledger transaction about the contract information or the usage information related to the target property which is obtained on the blockchain. Compared with the public chain, the consensus algorithm used by the consortium chain can be highly efficient and can meet the demand of high-frequency transaction volumes, such as the ledger transactions for the properties which are frequently generated. The delay of consensus can be very low, which can basically meet the real-time processing requirement. It can quickly and in real time store the ledger transaction in a newly generated block of the blockchain. Moreover, the trusted nodes in the consortium chain network (such as nodes on the government institutions) are taken as pre-selected accounting nodes, it can take into account both security and stability. In addition, the consensus algorithm of the consortium chain (such as PBFT) usually does not consume too much computing power, does not necessarily require circulation of tokens, so it has good usability. Therefore, in another embodiment, the blockchain is a consortium chain, and the node is a consortium chain node.

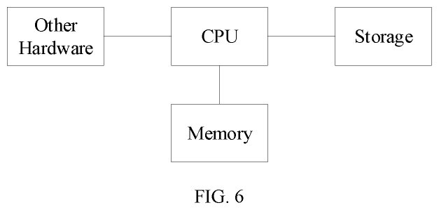

Corresponding to the embodiments of the process, some embodiments of the present disclosure further provides an apparatus 40 for storing property information based on a blockchain and an apparatus 50 for maintaining property information based on a blockchain. The apparatus 40 or 50 can be implemented by software, or can be implemented by hardware or a combination of software and hardware. Taking software implementation as an example, as a device in a logical sense, it is formed by reading corresponding computer program instructions into a memory through a CPU (Central Process Unit) of a device where it is located. From the hardware level, in addition to the CPU, the memory and the storage as shown in FIG. 6, the device in which the apparatus is located can include other hardware such as chips for wireless signal transmission and reception, and/or other hardware such as boards and cards for implementing network communication functions.

As shown in FIG. 4, this disclosure also provides an apparatus 40 for storing property information, and the apparatus is applied to a node of the blockchain. The apparatus 40 includes: a receiving unit 402 configured to receive an ledger transaction associated with a target property, where the ledger transaction includes a unique identification code of the target property and a ledger content; and a storing unit 404 configured to, after the ledger transaction is verified by a consensus of the blockchain nodes, store the unique identification code of the target property and the ledger content in a distributed database provided by the blockchain.

In some embodiments, the unique identification code of the target property is obtained by a node of the blockchain invoking a smart contract deployed on the blockchain, and the smart contract declares a logic that generates the unique identification code for the target property based on attribute information of the target property.

In some embodiments, the ledger content includes attribute information or contract information or usage sensing information of the target property.

The usage sensing information is obtained by an IoT sensor provided at the target property and transmitted to the node.

In some embodiments, the ledger content further includes respective hash values of other ledger transaction stored in the distributed database provided by the blockchain.

As shown in FIG. 5, this disclosure also provides an apparatus 50 for maintaining property information based on a blockchain, which can be applied to a node of the block chain. The apparatus 50 includes: an obtaining unit 502 configured to obtain a ledger transaction associated with a target property from a distributed database provided by the blockchain, where the ledger transaction includes a unique identification code of the target property and a ledger content; and an execution unit 504 configured to execute an application logic based on the ledger transaction.

In some embodiments, the unique identification code of the target property is obtained by a sending node of the ledger transaction invoking a smart contract deployed on the blockchain, and the smart contract declares a logic that generates the unique identification code for the target property based on attribute information of the target property.

In some embodiments, the ledger content includes attribute information of the target property.

The execution unit 504 is further configured to execute a creation logic for a contract related to the target property.

In some embodiments, the ledger content includes contract information related to the target property.

The execution unit 504 is further configured to perform contract information management on the target property or rental-sale information management on the target property.

In some embodiments, the ledger content includes usage sensing information of the target property, and the usage sensing information is obtained by an IoT sensor provided at the target property;

The execution unit 504 is further configured to perform usage management on the target property.

In some embodiments, the ledger content further includes respective hash values of other ledger transaction stored in the distributed database provided by the blockchain.

The obtaining unit 502 is further configured to obtain the other ledger transaction from the distributed database provided by the blockchain.

The execution unit 504 is further configured to perform usage process management on the target property.

For the implementation process of the function and effect of each unit in the apparatus 40 or 50, reference can be made to the implementation process of the corresponding steps in the method for storing property information based on a blockchain or the method for maintaining property information based on a blockchain, which are performed by a node on the blockchain for details. For related parts, reference can be made to the description of the method implementations, which will not be elaborated herein.

The apparatus examples described above are merely illustrative, wherein the units described as separate components can or cannot be physically separated, and the components displayed as units can or cannot be physical units, i.e., can be located in one place or can be distributed to multiple network modules. Some or all of the units or modules can be selected according to actual needs to achieve the objectives of solutions in the present disclosure. Those of ordinary skill in the art can understand and implement the present disclosure without any creative effort.

The apparatus, unit, or module illustrated in the examples can be implemented specifically by using a computer chip or an entity, or by using a product having a certain function. A typical embodiment device is a computer, and the specific form of the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

Corresponding to the method examples, the examples of the present disclosure also provides a computer device. As shown in FIG. 6, the computer device includes a memory and a processor. A computer program executable by the processor is stored on the memory, and the processor, when executing the stored computer program, implements the steps of the method for storing property information based on a blockchain, which is performed by a node on the blockchain in the examples of the present disclosure. For detailed description about each step of the method for storing property information based on a blockchain, which is performed by a node on the blockchain, reference can be made to the previous contents, which will not be repeated.

Corresponding to the method examples, the examples of the present disclosure also provides a computer device. As shown in FIG. 6, the computer device includes a memory and a processor. A computer program executable by the processor is stored on the memory, and the processor, when executing the stored computer program, implements the steps of the method for maintaining property information based on a blockchain, which is performed by a node on the blockchain in the examples of the present disclosure. For detailed description about each step of the method for maintaining property information based on a blockchain, which is performed by a node on the blockchain, reference can be made to the previous contents, which will not be repeated.

Corresponding to the method examples, the examples of the present disclosure also provides a computer readable storage medium having computer programs stored thereon. The computer program is executed by a processor to implement the steps of the method for storing property information based on a blockchain, which is performed by a node on the blockchain in the examples of the present disclosure. For detailed description about each step of the method for storing property information based on a blockchain, which is performed by a node on the blockchain, reference can be made to the previous contents, which will not be repeated.

Corresponding to the method examples, the examples of the present disclosure also provides a computer readable storage medium having computer programs stored thereon. The computer program is executed by a processor to implement the steps of the method for maintaining property information based on a blockchain, which is performed by a node on the blockchain in the examples of the present disclosure. For detailed description about each step of the method for maintaining property information based on a blockchain, which is performed by a node on the blockchain, reference can be made to the previous contents, which will not be repeated.

The above are some examples of the present disclosure, which are not intended to limit the disclosure. Any modification, equivalent substitution, or improvement made within the spirit and principle of the present disclosure shall be included within the protection scope of the disclosure.

In a configuration, a computing device includes one or more processors (CPUs), input/output interfaces, network interfaces, and memories.

The memories can include a non-permanent memory in a computer readable medium, a random access memory (RAM), and/or a non-volatile memory, and memories in other forms such as a read only memory (ROM) or a flash memory (flash RAM). Memory is an example of the computer readable medium.

The computer readable medium includes permanent and non-persistent, removable and non-removable media that can accomplish information storage by any method or technology. Information can be computer readable instructions, data structures, modules of a program, or other data.

Examples of the computer storage medium include, but are not limited to, a phase change memory (PRAM), a static random access memory (SRAM), a dynamic random access memory (DRAM), other types of random access memory (RAM), a read only memory (ROM), an electrically erasable programmable read only memory (EEPROM), a flash memory or other memory technologies, a compact disc read only memory (CD-ROM), a digital versatile disc (DVD) or other optical storage, a cartridge magnetic tape, a magnetic tape or disk storage or other magnetic storage devices or any other non-transmission media that can be used to store information accessible by a computing device. As defined herein, the computer readable medium does not include transitory computer readable media (transitory media) such as modulated data signals and carriers.

It should also be noted that the terms “including”, “comprising” or any other variants thereof are intended to cover non-exclusive inclusion, so that a process, method, product, or device that includes a series of elements includes not only those elements, but also other elements not explicitly listed, or those that are inherent to such process, method, product, or device. Without more restrictions, elements defined by the sentence “including a . . . ” do not exclude the existence of other identical elements in the process, method, product or device including the elements.

Those skilled in the art should understand that the examples of the present disclosure can be implemented as a method, a system, or a computer program product. Therefore, the examples of the present disclosure can take the form of an entirely hardware example, an entirely software example, or a software and hardware combined example. Moreover, the examples of the present disclosure can take the form of a computer program product implemented on one or more computer usable storage media (including but not limited to a magnetic disk storage, a CD-ROM, an optical storage, etc.) including computer usable program codes.

What is claimed is:

1. A computer-implemented method comprising:
receiving, by a first blockchain node of a blockchain, data characterizing a ledger transaction for a target property, the data characterizing the ledger transaction comprising a unique identification code of the target property and a ledger content;
generating, by the first blockchain node, the ledger transaction based on the data characterizing the ledger transaction for the target property, and releasing the ledger transaction to a block of the blockchain; and
after the ledger transaction is verified by a consensus of the blockchain, storing the unique identification code of the target property and the ledger content in a distributed database of the blockchain.

2. The computer-implemented method according to claim 1, further comprising:
invoking, by the first blockchain node, an identification smart contract deployed on the blockchain to obtain the unique identification code of the target property, wherein invoking the identification smart contract causes the identification smart contract to execute logic that generates the unique identification code for the target property based on attribute information of the target property.

3. The computer-implemented method according to claim 1, further comprising:
invoking, by the ledger transaction, a storage smart contract deployed on the blockchain, wherein invoking the storage smart contract causes the storage smart contract to execute logic that stores the unique identification code of the target property and the ledger content in the distributed database of the blockchain, based on the unique identification code of the target property and the ledger content.

4. The computer-implemented method according to claim 1, wherein the ledger content comprises one or more of attribute information, contract information, or usage sensing information for the target property.

5. The computer-implemented method according to claim 4, further comprising:
receiving, by the first blockchain node, usage sensing information, wherein the usage sensing information is obtained by an Internet of Things (IoT) sensor provided at the target property and transmitted to the first blockchain node.

6. The computer-implemented method according to claim 4, wherein the ledger content comprises a hash value of another ledger transaction stored in the distributed database of the blockchain for the target property.

7. The computer-implemented method according to claim 1, wherein the blockchain is a consortium blockchain, and the first blockchain node is a consortium blockchain node of the consortium blockchain.

8. The computer-implemented method according to claim 1, further comprising:
obtaining, by a second node device from the distributed database of the blockchain, the ledger transaction for the target property; and
executing application logic based on the ledger transaction to apply property information for the target property, the property information comprising a contract related to the target property.

9. The computer-implemented method according to claim 8, wherein executing the application logic comprises executing creation logic for the contract related to the target property.

10. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
receiving, by a first blockchain node of a blockchain, data characterizing a ledger transaction for a target property, the data characterizing the ledger transaction comprising a unique identification code of the target property and a ledger content;
generating, by the first blockchain node, the ledger transaction based on the data characterizing the ledger transaction for the target property, and releasing the ledger transaction to a block of the blockchain; and
after the ledger transaction is verified by a consensus of the blockchain, storing the unique identification code of the target property and the ledger content in a distributed database of the blockchain.

11. The system according to claim 10, the operations further comprising:
invoking, by the first blockchain node, an identification smart contract deployed on the blockchain to obtain the unique identification code of the target property, wherein invoking the identification smart contract causes the identification smart contract to execute logic that generates the unique identification code for the target property based on attribute information of the target property.

12. The system according to claim 10, the operations further comprising:
invoking, by the ledger transaction, a storage smart contract deployed on the blockchain, wherein invoking the storage smart contract causes the storage smart contract to execute logic that stores the unique identification code of the target property and the ledger content in the distributed database of the blockchain, based on the unique identification code of the target property and the ledger content.

13. The system according to claim 10, the operations further comprising:
obtaining, by a second node device from the distributed database of the blockchain, the ledger transaction for the target property; and
executing application logic based on the ledger transaction to apply property information for the target property, the property information comprising a contract related to the target property.

14. The system according to claim 13, wherein executing the application logic comprises executing creation logic for the contract related to the target property.

15. A non-transitory, computer-readable medium storing one or more instructions executable by a computer system to perform operations comprising:
receiving, by a first blockchain node of a blockchain, data characterizing an ledger transaction for a target property, the data characterizing the ledger transaction comprising a unique identification code of the target property and a ledger content;
generating, by the first blockchain node, the ledger transaction based on the data characterizing the ledger transaction for the target property, and releasing the ledger transaction to a block of the blockchain; and
after the ledger transaction is verified by a consensus of the blockchain, storing the unique identification code of the target property and the ledger content in a distributed database of the blockchain.

16. The computer-readable medium according to claim 15, the operations further comprising:
invoking, by the first blockchain node, an identification smart contract deployed on the blockchain to obtain the unique identification code of the target property, wherein invoking the identification smart contract causes the identification smart contract to execute logic that generates the unique identification code for the target property based on attribute information of the target property.

17. The computer-readable medium according to claim 15, the operations further comprising:
invoking, by the ledger transaction, a storage smart contract deployed on the blockchain, wherein invoking the storage smart contract causes the storage smart contract to execute logic that stores the unique identification code of the target property and the ledger content in the distributed database of the blockchain, based on the unique identification code of the target property and the ledger content.

18. The computer-readable medium according to claim 15, the operations further comprising:
obtaining, by a second node device from the distributed database of the blockchain, the ledger transaction for the target property; and
executing application logic based on the ledger transaction to apply property information for the target property, the property information comprising a contract related to the target property.

19. The computer-readable medium according to claim 18, wherein executing the application logic comprises executing creation logic for the contract related to the target property.
